(19) United States
(12) Patent Application Publication
(10) Pub. No.: US 2025/0229759 A1
(43) Pub. Date: Jul. 17, 2025

(54) ELECTRIC BRAKE RELEASE SYSTEM

(71) Applicant: Club Car, LLC, Evans, GA (US)

(72) Inventors: David Schnelle, Martinez, GA (US); Ryan Datz, Augusta, GA (US)

(21) Appl. No.: 18/414,683

(22) Filed: Jan. 17, 2024

(51) Int. Cl. B60T 13/74; B60R 16/033; B60T 17/20

(52) U.S. Cl. CPC B60T 13/743; B60R 16/033; B60T 17/20

(57) ABSTRACT

A personal transportation vehicle includes a seating area, at least one electric brake, and a receptacle containing electrical connectors that connect to the at least one electric brake. The seating area is sized to receive a driver operating the personal transportation vehicle. The at least one electric brake is disposed in an engaged position when an insufficient amount of power is delivered to the at least one electric brake and is disposed in a disengaged position when a sufficient amount of power is delivered to the at least one electric brake. In the engaged position, the at least one electric brake prevents the personal transportation vehicle from moving. The receptacle is accessible from the seating area during operation of the personal transportation vehicle.

### TECHNICAL FIELD

The present application generally relates to a brake system for a personal transportation vehicle and more particularly, but not exclusively, to techniques for releasing an electric brake system of a personal transportation vehicle.

### BACKGROUND

Personal transportation vehicles such as golf carts, all-terrain vehicles, utility vehicles or the like can often include electric braking systems. The electric braking systems can be electrically engaged or electrically released. Electrically engaged brakes often include friction surfaces that may be forced together electromagnetically to provide a braking force. Electrically released brakes typically include a biasing mechanism that forces friction and/or locking surfaces together unless separated by an electromagnetically applied force.

Regardless of how electrically released braking systems are implemented, electrically released braking systems can function as a parking brake and/or to stop a vehicle in the absence of power to the braking system, such as when a normal power source of the vehicle cannot supply sufficient power to the vehicle. Thus, if an unpowered personal transportation vehicle with an electrically released braking system needs to be moved, the braking system must be disengaged. Often, this requires a user to leave the vehicle's seating area and mechanically disengage the braking system. For example, a user may need to leave the seating area and access components disposed beneath the seat and/or move to an access point in the rear of the vehicle to disengage an electronic brake system.

However, these solutions are often not ideal because they may allow the vehicle to move freely without a passenger in the seating area to control the vehicle. Thus, if the vehicle is disposed on a slope, the vehicle might roll away in an uncontrolled manner, causing damage to the vehicle and/or its surroundings. Alternatively, such solutions might only be available in specific locations (e.g., flat service areas). Moreover, any solutions that require a user to disengage the brake system by leaning into the vehicle or to otherwise have any part of their person positioned in line with a direction in which any part of portion of the personal transportation vehicle may freely roll after release of the brake system are extremely dangerous for the user. This is because disengaging the electrically released braking system transitions the personal transportation vehicle from a static configuration to a dynamic configuration (i.e., a configuration where the vehicle can roll) and, thus, immediately after disengagement, the vehicle can roll into/over the user disengaging the brake in such a position.

### SUMMARY

According to one embodiment of the present application, a personal transportation vehicle is provided. The personal transportation vehicle includes a seating area, at least one electric brake, and a receptacle containing electrical connectors that connect to the at least one electric brake. The seating area is sized to receive a driver operating the personal transportation vehicle. The at least one electric brake is disposed in an engaged position when an insufficient amount of power is delivered to the at least one electric brake and is disposed in a disengaged position when a sufficient amount of power (e.g., 24-48 V) is delivered to the at least one electric brake. In the engaged position, the at least one electric brake prevents the personal transportation vehicle from moving. The receptacle is accessible from the seating area during operation of the personal transportation vehicle. Among other advantages, the receptacle allows a user to operate (e.g., disengage) the at least one electric brake from within the seating area, so that the user can safely transition a personal transportation vehicle from a static configuration to a dynamic configuration after a fault or lack of electrical power causes the electric brake to move into an engaged position.

In some embodiments, the receptacle is electrically isolated from operating components of the personal transportation vehicle, except for the at least one electric brake. Thus, for example, in some instances the personal transportation vehicle operates in a tow or free-rolling mode when a portable power source is electrically connected to the receptacle and delivering the sufficient amount of power to move the at least one electric brake to the disengaged position. Additionally or alternatively, the personal transportation vehicle may be unable to operate in a drive mode while the portable power source is a sole source of power delivering the sufficient amount of power to disengage the at least one electric brake. Among other advantages, this may prevent a user from draining the power in the portable power source, which would create yet another situation where the electric brake re-engages.

Moreover, in some embodiments, the receptacle is located in a console of the personal transportation vehicle. This may ensure the receptacle is easily accessible, e.g., from a position in which the user would otherwise be positioned while driving the personal transportation vehicle (e.g., a position in which the user may grasp a steering wheel).

Additionally or alternatively, the personal transportation vehicle may include one or more main power sources configured to operate the at least one electric brake to move the at least one electric brake between the engaged position and the disengaged position unless prevented by a fault or by lack of available power. Thus, the portable power source may only be required when a battery source of the personal transportation vehicle is dead or depleted, or when the personal transportation vehicle experiences a fault (e.g., due to damage, wear, etc.). Similarly, in some instances, the at least one electric brake is a parking brake and the personal transportation vehicle comprises additional brakes. Thus, disengaging the at least one electric brake may allow a user to drive and control the personal transportation vehicle.

Still further, in some instances, the personal transportation vehicle includes a portable power source that is removably installable in the receptacle. In such instances, the receptacle may be configured to removably, electrically connect to the portable power source and/or the receptacle may removably, mechanically couple the portable power source to the personal transportation vehicle. Among other advantages, a mechanical connection may ensure the portable power source remains electrically connected to the electric brake as and after the vehicle shifts from a static state to a dynamic state. Still further, in some instances, the portable power source is contained within a canister. The canister can have a handle on at least one side that is not adjacent to the receptacle upon when the canister is installed in the cavity, e.g., to help with installation into and removal from the receptacle. The canister and/or the portable power source may also be sized to be hand-carried so that a user can easily use the portable power source across multiple personal transportation vehicles (e.g., at a service location).

According to another embodiment, an electric brake system is presented herein. The electric brake system includes at least one electric brake and a portable power source. The at least one electric brake is movable between an engaged position and a disengaged position. In the engaged position, the at least one electric brake prevents a personal transportation vehicle in which it is included from moving. The at least one electric brake is disposed in the engaged position when an insufficient amount of power is delivered to the at least one electric brake and is disposed in a disengaged position when a sufficient amount of power is delivered to the at least one electric brake. The portable power source, which can be removably, electrically connected to the at least one electric brake, provides sufficient power to open the at least one electric brake. Thus, among other advantages, the at least one electric brake can be selectively disengaged regardless of an operational state of operating components included in the personal transportation vehicle in which the at least one electric brake is included. The at least one electric brake and/or portable power source may also include any combination of features discussed herein and may realize any advantages thereof.

According to yet another embodiment, a portable power system for a personal transportation vehicle is presented herein. The portable power system includes a portable power source and a canister. The portable power source is configured to deliver an amount of power sufficient to power at least one electric brake to move the at least one electric brake out an engaged position that prevents the personal transportation vehicle from moving. The canister houses the portable power source and includes external electrical connectors configured to engage connectors of the personal transportation vehicle that are accessible from a seating area of the personal transportation vehicle. Thus, among other advantages, the portable power system can safely disengage at least one electric brake regardless of an operational state of operating components included in the personal transportation vehicle in which the at least one electric brake is included. The portable power source may include any features, and realize any advantages of, like components discussed herein.

Other embodiments include apparatuses, systems, devices, hardware, methods, and combinations for disengaging an electric braking system. Further embodiments, forms, features, aspects, benefits, and advantages of the present application shall become apparent from the description and figures provided herewith.

### BRIEF DESCRIPTION OF THE DRAWINGS

FIG. 1 is a simplified block diagram of an exemplary personal transportation vehicle with an electric brake system, according to an example embodiment.

FIG. 2 is a simplified block diagram of components of a personal transportation vehicle, according to an example embodiment.

FIG. 3 a simplified block diagram of a top view of a seating area in a personal transportation vehicle, according to an example embodiment.

FIG. 4 is a simplified block diagram of components of a receptacle and a canister that can implement the techniques presented herein, according to an example embodiment.

FIG. 5 is a block diagram of a computing device that may be configured to perform a portion of the techniques presented herein, according to an example embodiment.

### DETAILED DESCRIPTION

Systems and apparatuses for an electric brake release mechanism are presented herein. These techniques may be utilized in the event of a failure of the main power system of a vehicle (e.g., due to a fault or due to low battery) and generally involve disengaging an electrical brake by providing power to the electric brake via a portable power source. One exemplary system may include an electric brake and associated components that can be powered by a portable power source. The system may be electrically isolated from other systems on the personal transportation vehicle. Also, the other systems of the personal transportation vehicle may not operate while the portable power source is electrically coupled to the system. One exemplary apparatus may include at least one electric brake, associated components, a portable power source to supply sufficient power to disengage the electric brake, a receptacle to electrically and mechanically couple the portable power source to the personal transportation vehicle, and optionally a canister to assist with connecting the portable power source to the receptacle.

Typically, when a vehicle with an electrically released brake loses its main power supply, the vehicle will be locked in-place, unable to move unless a user exits the vehicle and disengages the electrically released brake, e.g., by accessing a switch inside or under the personal vehicle. The techniques described herein release an electric brake when a personal transportation vehicle's main power system has insufficient power to do so and, advantageously, allow a user to do so without exiting, or even modifying, the seating area of the personal transportation vehicle. This is because the techniques presented herein provide a portable power source that is selectively coupleable to the electrically released brake system from the seating area. In at least some embodiments, the portable power source is coupled to the electrically released brake system by installing the portable power source into a receptacle included in the personal transportation vehicle.

The receptacle is preferably provided in a location that is accessible from the seating area. Advantageously, keeping the user within the confines of the vehicle during release of the brake safeguards the user from all manner of injury and hazard which may arise from having a portion of their body on the ground and a portion of their body within a vehicle that is moving relative to the ground. That is, the techniques presented herein avoid hazards associated with releasing a brake system while standing outside the vehicle, thereby drastically reducing risk to the operator relative to conventional techniques.

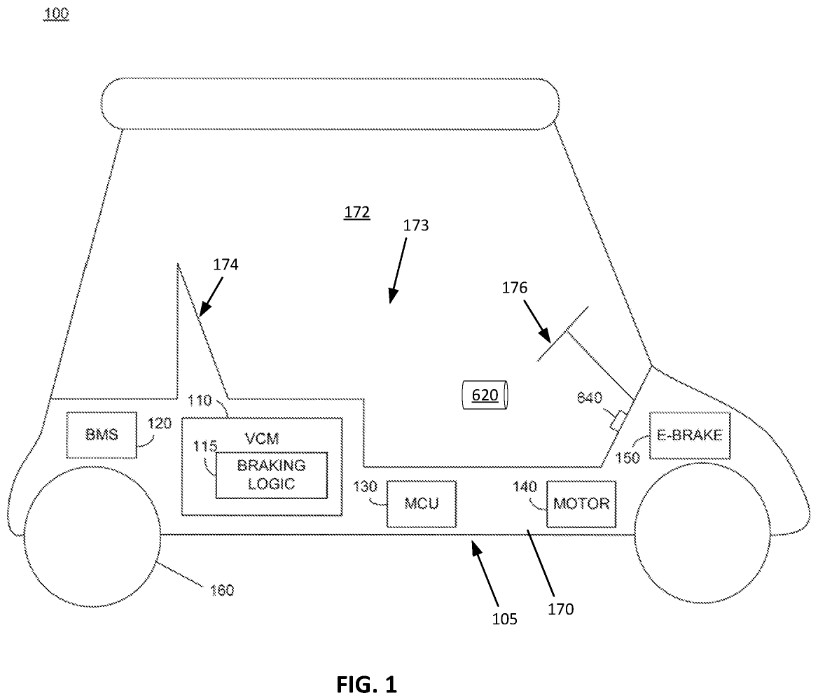

Referring now to FIG. 1, an example embodiment shows a personal transportation vehicle 100 (e.g., a golf cart), which may be referenced herein as a vehicle, with a backup power system for an electrically released braking system. The vehicle 100 includes a VCM 110 that is configured to monitor and control the operation of the vehicle 100. The VCM 110 includes braking logic 115 that may control standard operations of an e-brake 150. For example, the braking logic 115 may cause a Battery Management System (BMS) 120 to selectively provide electrical power to an electrically released brake 150, which may be referred to herein as an e-brake 150, and various other components during normal operations (e.g., when the vehicle 100 is powered and a user is depressing a gas pedal). A Motor Controller Unit (MCU) 130 is configured to distribute the power from the BMS 120 to the systems of the vehicle 100. In one example, the MCU 130 may provide high voltage (e.g., 48-72 V) and low voltage (e.g., 12 V) power.

The vehicle 100 includes one or more motor(s) 140 configured to provide motive power to the vehicle 100. For example, the MCU 130 may provide high voltage power from the BMS 120 to the motor 140, which drives the vehicle 100 by rotating one or more wheels 160 of the vehicle 100. In one example, the motor 140 may include regenerative braking to recharge the battery in the BMS 120 when decelerating the vehicle 100.

The e-brake 150 included in vehicle 100 is an electromagnetic brake that typically engages as a parking brake when the vehicle 100 is stopped. When the MCU 130 receives a control input to drive the motor 140, the MCU 130 also drives the e-brake 150 to disengage the e-brake 150 and allow the vehicle 100 to move its wheels 160. Additionally or alternatively, the e-brake 150 might provide braking to slow the vehicle. It is also contemplated that the e-brake 150 may be one brake included on vehicle 100 and that the vehicle 100 may include additional brakes, which can be mechanical, electrical, or some combination thereof.

In one example, the e-brake 150 is configured such that initially separating the friction surfaces and releasing the e-brake 150 requires more power (e.g., a higher voltage) than maintaining the separation of the friction surfaces. For example, 24-48 V may be sufficient to initially open the brake, and 12-36 V may be sufficient to hold the brake open. Since the e-brake 150 typically remains energized the entire time the vehicle is in motion, this configuration of the e-brake 150 allows for more efficient operation by only requiring high power for a relatively short time to initially separate the friction surfaces.

Still referring to FIG. 1, in the depicted embodiment, the aforementioned components (e.g., VCM 110, BMS 120, MCU 130, motor 140, and e-brake 150) are generally located within the main body 170 of the vehicle. Thus, these components—which are collectively referred to herein as operating components 105—are generally hidden from and inaccessible to an operator of the vehicle when the operator is in a seating area 172 of the vehicle 100. In the depicted embodiment, the seating area 172 includes a front-facing seat 174 that faces a steering wheel 176 of the vehicle 100. The front-facing seat 174 may also generally face, or position the user in a position to access, other controls of the vehicle 100. While not shown, controls may include foot pedals, shifters, ignition switches, and/or any other device, component, switch, etc. that might help a user control operation of vehicle 100. Thus, when an operator is disposed in seating area 172 (e.g., when a user is sitting on seat 174) a user may be able to fully operate the vehicle (e.g., by operating steering wheel 176, operating a control, etc.).

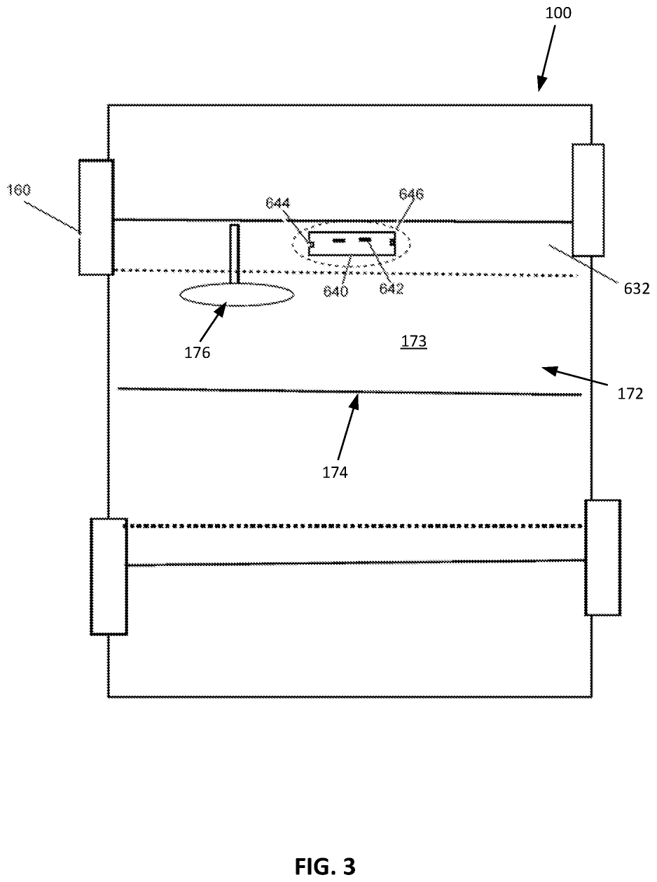

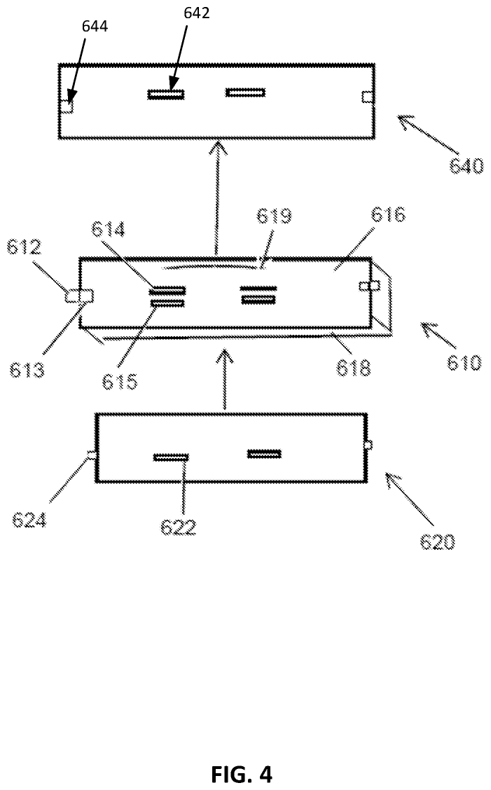

Critically, with the techniques presented herein, the seating area 172 also includes a receptacle 640 configured to receive a portable power source 620. The receptacle 640 is generally integrated into the seating area 172 of vehicle 100, e.g., on an exposed or outwardly facing portion of main body 170. As is described in further detail below with reference to FIGS. 3 and 4, the receptacle 640 is generally configured to physically receive, mechanically couple to, and electrically connect to a portable power source 620 to selectively supply power to e-brake 150 and disengage the e-brake 150 when other power sources are not available.

In the depicted embodiment, the receptacle 640 is generally depicted proximate the steering wheel 176 of the vehicle 100. However, in other embodiments, the receptacle 640 may be positioned in any desired location within seating area 172. That is, receptacle 640 may be positioned on any portion of the main body 170 of vehicle 100 that is accessible to a person sitting in seating area 172. Moreover, while the depicted embodiment depicts a seating area 172 with only a front-facing seat 174, other embodiments implementing the techniques presented herein may include a wide variety of seating arrangements and/or seating area configurations. For example, seating area 172 may include multiple rows of seats, foldable seats, cargo areas, and/or any other features. That said, it may be beneficial to provide the receptacle 640 in/adjacent a portion of the seating area 172 from which a user can access one or more controls of the vehicle 100 (including steering wheel 176). In such instances, the user will be able to access the one or more controls while/when the user installs a portable power source 620 in receptacle 640. Thus, this portion/section of the seating area 172 may be referred to herein as driving portion 173 of seating area 172.

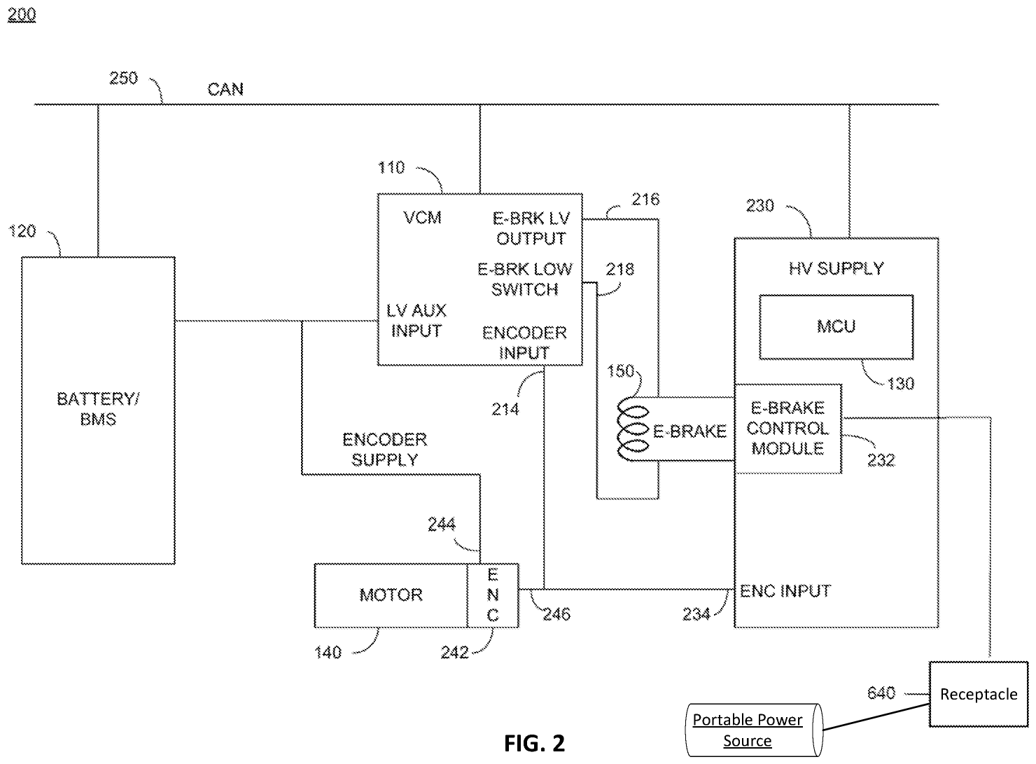

Referring now to FIG. 2, a simplified schematic 200 of the power system of vehicle 100 is shown. The schematic 200 includes the VCM 110, the BMS 120, the MCU 130, the motor 140, and the e-brake 150 shown in FIG. 1. As can be seen, the VCM 110 includes an encoder input 214, an e-brake output 216 and an e-brake switch output 218. The VCM 110 is also operatively coupled to the BMS 120 and the MCU 130 via electrical connections and/or a Controller Area Network (CAN) bus 250 that allows these components to exchange information.

However, in schematic 200, the MCU 130 is included in a high voltage power supply 230 with an e-brake control module 232 and an encoder input 234. The receptacle 640 is also operably coupled to e-brake 150 so that a portable power source 620 in receptacle 640 can deliver power to e-brake 150. Thus, a portable power source 620 in receptacle 640, the high voltage power supply 230 and/or the BMS 120 (via the VCM 110) may be configured to provide the power to release the e-brake 150 of vehicle 100.

For example, a portable power source 620 in receptacle 640, the high voltage power supply 230 and/or the BMS 120 (via VCM 110) may provide power to a coil of an electromagnet of e-brake 150 that creates a force sufficient to overcome a biasing force of a spring mechanism of e-brake 150 that urges friction surfaces of e-brake 150 together. This will then release the e-brake 150 and/or maintain the e-brake 150 in a released state. Importantly, since the receptacle 640 can deliver power to the e-brake 150, the e-brake 150 can still be released when the BMS 120 and/or high voltage power supply 230 (each of which may be referred to as a “main power supply” for the purposes of this application) are not able to power the e-brake 150, such as due to malfunctioning, lack/drainage of power, and/or a disconnection.

Moreover, in some instances, a portable power source 620 positioned in receptacle 640 may only power a limited number of functions of vehicle 100. For example, when portable power source 620 is electrically connected to the vehicle 100, power may only be delivered from portable power source 620 to the e-brake 150 and not to other components of the operating components 105. That is, the receptacle 640 may be electrically coupled to e-brake 150 but electrically isolated (physically or via virtual configurations) from the other systems of the vehicle 100 when the portable power source 620 is electrically connected to the receptacle 640.

Electrical isolation of the portable power source 620 and e-brake 150 can prevent all or only specified systems and/or functionalities of vehicle 100 from receiving power. For example, electrical isolation may allow the e-brake 150, but not motor 140, to receive power so that, for example, the vehicle 100 can be unlocked into a tow mode (i.e., a mode in which the vehicle 100 can freely roll, but has no motive force) but cannot operate in a drive mode (where motor 140 drives propulsion via wheels 160). Additionally or alternatively, a component of vehicle 100, such as VCM 110 may limit vehicle functionality when the portable power source 620 is electrically coupled to e-brake 150. The VCM 110 might detect the presence of a portable power source 620 in the receptacle based on a signal from the e-brake control module 232 (e.g., as communicated via bus 250) and/or through electrical circuitry. Additionally or alternatively, the BMS 120 and/or MCU 130 might ensure that the portable power source 620 only powers a limited number of components/functionalities (e.g., only releasing e-brake 150 to allow a tow mode without enabling a drive mode).

In the depicted embodiment, the motor 140 includes an encoder 242 with a power input 244 and a speed output 246, and the encoder power input 244 receives power from the BMS 120. The encoder speed output 246 can provide a signal that allows the VCM 110 and the high voltage power supply 230 to measure the speed of the motor 140 through the encoder input 214 and the encoder input 234, respectively. In one example, the speed of the encoder 242 and the motor 140 are directly proportional to the speed of vehicle 100. The speed of the vehicle might help to determine how to control the e-brake 150; however, the encoder 242 is also not necessary to implement the techniques presented herein. Indeed, embodiments implementing the techniques presented herein may do so in systems without a motor encoder 242 or with any alternative arrangement of motor encoders.

Although not shown, in some instances, the schematic 200 may also be connected to an indicator (mechanical or electrical) and/or graphical user interface (GUI) that may, among other functions, indicate that the e-brake 150 cannot be released/unlocked. Additionally or alternatively, controls of vehicle 100, such as a gas pedal, may be non-responsive, indicating that the e-brake 150 cannot be released/unlocked. For example, if a fault in the high voltage power supply 230 prevents the e-brake control module 232 from maintaining power to the e-brake 150, the e-brake 150 may engage. Then, the VCM 110 may detect this fault in the high voltage power supply 230 and provide an indication of such.

Additionally or alternatively, in some instances where the VCM 110 detects a fault or malfunction in high voltage power supply 230, the VCM 110 may attempt to release the e-brake 150 with low voltage power transmitted to e-brake via e-brake output 216 and e-brake switch output 218. This may maintain the e-brake 150 in a released state with power supplied from BMS 120. However, in other instances, the VCM 110 may not be configured to remedy faults or inoperability of the high voltage power supply 230. In fact, in some embodiments, the VCM 110 need not be coupled to low voltage power. In such instances, a user may release/unlock the e-brake 150 by installing a portable power source 620 in receptacle 640. Alternatively, the portable power source 620 might provide a solution when neither low voltage power from BMS 120 nor high voltage power from high voltage power supply 230 is available.

Referring now to FIG. 3, this Figure schematically illustrates a top view of vehicle 100 that, among other items, helps illustrate the receptacle 640. As mentioned above, with the techniques presented herein, a vehicle operator can use a portable power source 620 to disengage the e-brake 150 when vehicle 100 is in a power loss state. In some instances, the vehicle 100 may be in a power loss state when there is not enough power to sufficiently power the vehicle or disengage the e-brake 150 from the wheels 160. Additionally or alternatively, the vehicle 100 may be in a power loss state when the vehicle 100 does not have enough electrical power to properly operate the vehicle's 100 lighting, motor, or other systems, either separately or simultaneously. Still further, in some instances, the vehicle 100 may be in a power loss state when there is an adequate amount of electrical power available at the vehicle 100, but a malfunction is rendering the vehicle 100 inoperable from improper power delivery (e.g., the power cannot be delivered to the e-brake 150).

Regardless of how or why vehicle 100 is in a power loss state, the e-brake 150 will be powerless when the vehicle is in a power loss state. The e-brake 150 will be engaged or “in a closed state” when powerless and will remain in such a closed state until power is delivered to the e-brake 150 to move the e-brake 150 into an open state. Accordingly, the receptacle 640 is positioned in a location that is easily accessible for the driver/operator of the vehicle 100 so that a driver can selectively install a portable power source 620 into the receptacle 640 if/when the vehicle 100 enters a power loss state.

In view of the foregoing, the depicted embodiments include the receptacle 640 within a cavity 646 of a console 632 of the vehicle 100, such as center console, a front console (i.e., a dashboard, etc.). Thus, a user can easily install a portable power source 620 into the receptacle 640 from a seating area 172 without leaving a seated position. Installing the portable power source 620 into the receptacle may deliver power to the e-brake to move the e-brake 150 from a closed state to an open state. As mentioned above, the seating area 172 is the location where the driver is disposed when ordinarily operating the vehicle 100.

The receptacle 640, and perhaps the cavity 646 that it sits within, can also be outside of the console 632 provided that a person operating vehicle 100 can safely access the receptacle 640 without jeopardizing the user's safety. For example, the receptacle 640 should be positioned such that the vehicle 100 may not freely move into the user when the user is interacting with the vehicle 100 to install the portable power source 620 into the receptacle 640. This may prevent the vehicle 100 (e.g., its wheels 160) from rolling over or into the user if the portable power source 620 moves the vehicle out of a power loss state. Thus, while the receptacle 640 may be disposed in a wide variety of locations, (including locations outside the seating area 630), the receptacle 640 should, in most instances, be accessible by a user who is disposed in the seating area 630.

Generally, when the portable power source 620 is installed in receptacle 640, the portable power source 620 transmits electricity to the vehicle 100 via receptacle 640. The portable power source 620 may also be, but is not required to be, mechanically coupled to the vehicle 100 via the receptacle 640. The mechanical coupling may be achieved with mechanical couplers 644. Meanwhile, the receptacle 640 has electrical connectors 642 which electrically connect the receptacle 640 to the e-brake 150.

In some embodiments, the electrical connectors 642 also connect the receptacle 640 to the portable power source 620, but in other embodiments two sets of connectors may be used (e.g., one set to connect receptacle 640 to e-brake 150 and another set to connect receptacle 640 to the portable power source 620). In any case, the electrical connectors 642 do not permanently connect the portable power source 620 to the receptacle 640. Thus, the user can removably connect the portable power source 620 to the receptacle 640 and, among other advantages, the user can easily replace a portable power source 620 used with a specific vehicle (e.g., to recharge or dispose of the first portable power source 620). Additionally or alternatively, the user can transport the portable power source 620 from one vehicle 100 to another (or to another component or apparatus compatible with the portable power source 620). In some embodiments, the electrical connectors 642 include metallic contacts exposed on receptacle 640 and the portable power source 620 includes electrical connectors 622 that are corresponding metallic contacts. Alternatively, the electrical connectors 642, 622 can be a set of corresponding male and female power connectors or any other connectors configured to transmit electrical power.

The portable power source 620 can also connect mechanically to the receptacle 640 via mechanical couplers 624 that interface with mechanical couplers 644 included in or on the receptacle 640. Again, mechanical couplers 624 and 644 need not permanently couple the portable power source 620 to the receptacle 640. For example, the portable power source 620 can be mechanically connected to the receptacle 640 via a “click and lock” mechanism (e.g., a detent lock), snap fit, interference fit, friction fit, press fit, threading (i.e. akin to modern light bulb designs), or any other removable mechanical coupling now known or developed hereafter.

Referring now to FIG. 4, in some embodiments, the portable power source 620 can be contained, removably or irremovably, within a canister 610 that is removably coupleable to the receptacle 640. The canister 610 can help facilitate a user's transportation, installation, and use of portable power source 620. Thus, in some instances, the canister 610 may have a handle 619 on a first surface 616. Additionally or alternatively, the canister 610 can include any other features that facilitate handling, transportation, and/or installation of the canister 610. For example, the canister 610 can include an interface to mechanically couple the portable power source 620 to the canister 610 and/or to couple the canister 610 to a carrier while not in use. Moreover, regardless of whether the canister 610 includes features that facilitate transportation, the portable power source 620, with or without canister 610, may be sufficiently small so that a user can hand carry the portable power source 620 (with or without canister 610). That is, power source 620, with or without canister 610, may be graspable and sufficiently light enough that a user can easily hand carry the power source 620 to move it to and from a vehicle 100.

In the depicted embodiment, the canister 610 is substantially cuboidal. Thus, a first surface 616 of the canister 610 faces the user during installation of the canister 610 into a receptacle 640. In other words, the first surface 616 is distal from the receptacle 640 (e.g., not adjacent a surface of the receptacle 640 with electrical connectors 642) during installation of the canister 610 into the receptacle 640. Meanwhile, a second surface 618 of the canister 610 is disposed opposite the first surface 616 and abuts the receptacle 640 when the canister 610 is installed in receptacle 640. However, in other embodiments, the canister 610 need not be cuboidal and can be any shape or size, e.g., to interface with a specific size of receptacle 640. Indeed, in some instances, different canisters 610 may be sized and shaped (and otherwise configured) for different receptacles 640 included on different vehicles 100.

Moreover, in some embodiments, one or both of the first surface 616 and the second surface 618 may be openable to allow the portable power source 620 to be removably installed in an interior cavity of the canister 610. Alternatively, one or both of the first surface 616 and the second surface 618 may be permanently affixed to the remainder of the canister 610 (e.g., via welding) after a the portable power source 620 is installed in the interior cavity of the canister 610 during manufacturing of the canister 610. Still further, in other embodiments, any other wall or surface of the canister 610 may be configured to allow installation of the portable power source 620 within the canister 610, during or after manufacture thereof (with or without allowing access thereto).

Still referring to FIG. 4, the canister can, in some instances, incorporate mechanical couplers 612, 613 and electrical connectors 614, 615 to interface with corresponding components of the receptacle 640 and the portable power source 620, respectively. The canister 610 and portable power source 620 may utilize the same mechanical couplers and/or electrical connectors, different mechanical couplers and/or electrical connectors, or any combination thereof.

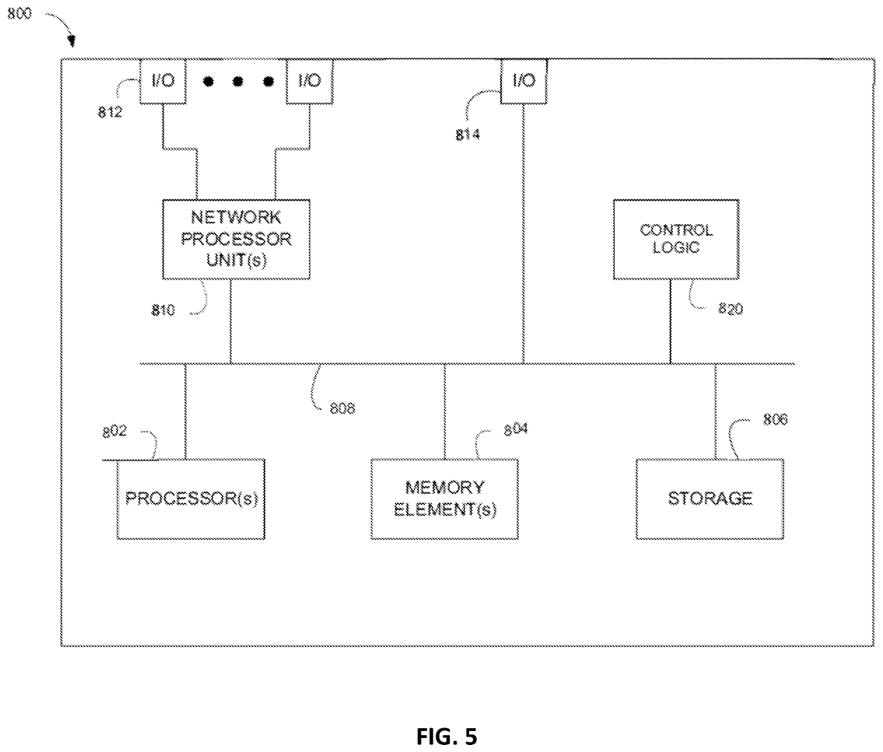

FIG. 5 illustrates a hardware block diagram of a computing device 800 that may perform functions associated with operations discussed herein in connection with the techniques depicted in FIGS. 1-4. For example, in various embodiments, a computing device, such as computing device 800 or any combination of computing devices 800, may be configured as any entity/entities (e.g., VCM 110, BMS 120, MCU 130, etc.) discussed herein, in order to perform operations of the various techniques discussed herein. For example, computing device 800 may be representative of a VCM 110 that detects power being delivered from the portable power source 620 to e-brake 150.

In at least one embodiment, the computing device 800 may include one or more processor(s) 802, one or more memory element(s) 804, storage 806, a bus 808, one or more network processor unit(s) 810 interconnected with one or more network input/output (I/O) interface(s) 812, one or more I/O interface(s) 814, and control logic 820. In various embodiments, instructions associated with logic for computing device 800 can overlap in any manner and are not limited to the specific allocation of instructions and/or operations described herein.

In at least one embodiment, processor(s) 802 is/are at least one hardware processor configured to execute various tasks, operations and/or functions for computing device 800 as described herein according to software and/or instructions configured for computing device 800. Processor(s) 802 (e.g., a hardware processor) can execute any type of instructions associated with data to achieve the operations detailed herein. In one example, processor(s) 802 can transform an element or an article (e.g., data, information, classical bits, qubits) from one state or thing to another state or thing. Any of potential processing elements, microprocessors, digital signal processor, baseband signal processor, modem, PHY, controllers, systems, managers, logic, and/or machines described herein can be construed as being encompassed within the broad term ‘processor’.

In at least one embodiment, memory element(s) 804 and/or storage 806 is/are configured to store data, information, software, and/or instructions associated with computing device 800, and/or logic configured for memory element(s) 804 and/or storage 806. For example, any logic described herein (e.g., braking logic 115, control logic 820) can, in various embodiments, be stored for computing device 800 using any combination of memory element(s) 804 and/or storage 806. Note that in some embodiments, storage 806 can be consolidated with memory element(s) 804 (or vice versa), or can overlap/exist in any other suitable manner.

In at least one embodiment, bus 808 can be configured as an interface that enables one or more elements of computing device 800 to communicate in order to exchange information and/or data. Bus 808 can be implemented with any architecture designed for passing control, data and/or information between processors, memory elements/storage, peripheral devices, and/or any other hardware and/or software components that may be configured for computing device 800.

In various embodiments, network processor unit(s) 810 may enable communication between computing device 800 and other systems, entities, etc., via network I/O interface(s) 812 (wired and/or wireless) to facilitate operations discussed for various embodiments described herein. In various embodiments, network processor unit(s) 810 can be configured as a combination of hardware and/or software, such as one or more Ethernet driver(s) and/or controller(s) or interface cards, Fibre Channel (e.g., optical) driver(s) and/or controller(s), wireless receivers/transmitters/transceivers, baseband processor(s)/modem(s), and/or other similar network interface driver(s) and/or controller(s) now known or hereafter developed to enable communications between computing device 800 and other systems, entities, etc. to facilitate operations for various embodiments described herein. In various embodiments, network I/O interface(s) 812 can be configured as one or more Ethernet port(s), Fibre Channel ports, CAN bus ports, any other I/O port(s), and/or antenna(s)/antenna array(s) now known or hereafter developed. Thus, the network processor unit(s) 810 and/or network I/O interface(s) 812 may include suitable interfaces for receiving, transmitting, and/or otherwise communicating data and/or information in a classical network environment.

I/O interface(s) 814 allow for input and output of data and/or information with other entities that may be connected to computing device 800. For example, I/O interface(s) 814 may provide a connection to external devices such as a keyboard, keypad, a touch screen, accelerator pedal, brake pedal, steering mechanism, and/or any other suitable input and/or output device now known or hereafter developed. In some instances, external devices can also include portable computer readable (non-transitory) storage media such as database systems, thumb drives, portable optical or magnetic disks, and memory cards. In still some instances, external devices can be a mechanism to display data to a user, such as, for example, a computer monitor, a display screen, or the like.

In various embodiments, control logic 820 can include instructions that, when executed, cause processor(s) 802 to perform operations, which can include, but not be limited to, providing overall control operations of computing device; interacting with other entities, systems, etc. described herein; maintaining and/or interacting with stored data, information, parameters, etc. (e.g., memory element(s), storage, data structures, databases, tables, etc.); combinations thereof, and/or the like to facilitate various operations for embodiments described herein.

The programs described herein (e.g., control logic 820) may be identified based upon application(s) for which they are implemented in a specific embodiment. However, it should be appreciated that any particular program nomenclature herein is used merely for convenience; thus, embodiments herein should not be limited to use(s) solely described in any specific application(s) identified and/or implied by such nomenclature.

In various embodiments, entities as described herein may store data/information in any suitable volatile and/or non-volatile memory item (e.g., magnetic hard disk drive, solid state hard drive, semiconductor storage device, random access memory (RAM), read only memory (ROM), erasable programmable read only memory (EPROM), application specific integrated circuit (ASIC), etc.), software, logic (fixed logic, hardware logic, programmable logic, analog logic, digital logic), hardware, and/or in any other suitable component, device, element, and/or object as may be appropriate. Any of the memory items discussed herein should be construed as being encompassed within the broad term ‘memory element’. Data/information being tracked and/or sent to one or more entities as discussed herein could be provided in any database, table, register, list, cache, storage, and/or storage structure: all of which can be referenced at any suitable timeframe. Any such storage options may also be included within the broad term ‘memory element’ as used herein.

Note that in certain example implementations, operations as set forth herein may be implemented by logic encoded in one or more tangible media that is capable of storing instructions and/or digital information and may be inclusive of non-transitory tangible media and/or non-transitory computer readable storage media (e.g., embedded logic provided in: an ASIC, digital signal processing (DSP) instructions, software [potentially inclusive of object code and source code], etc.) for execution by one or more processor(s), and/or other similar machine, etc. Generally, memory element(s) 804 and/or storage 806 can store data, software, code, instructions (e.g., processor instructions), logic, parameters, combinations thereof, and/or the like used for operations described herein. This includes memory element(s) 804 and/or storage 806 being able to store data, software, code, instructions (e.g., processor instructions), logic, parameters, combinations thereof, or the like that are executed to carry out operations in accordance with teachings of the present disclosure.

In some instances, software of the present embodiments may be available via a non-transitory computer useable medium (e.g., magnetic or optical mediums, magneto-optic mediums, CD-ROM, DVD, memory devices, etc.) of a stationary or portable program product apparatus, downloadable file(s), file wrapper(s), object(s), package(s), container(s), and/or the like. In some instances, non-transitory computer readable storage media may also be removable. For example, a removable hard drive may be used for memory/storage in some implementations. Other examples may include optical and magnetic disks, thumb drives, and smart cards that can be inserted and/or otherwise connected to a computing device for transfer onto another computer readable storage medium.

Note that in this Specification, references to various features (e.g., elements, structures, nodes, modules, components, engines, logic, steps, operations, functions, characteristics, etc.) included in ‘one embodiment’, ‘example embodiment’, ‘an embodiment’, ‘another embodiment’, ‘certain embodiments’, ‘some embodiments’, ‘various embodiments’, ‘other embodiments’, ‘alternative embodiment’, and the like are intended to mean that any such features are included in one or more embodiments of the present disclosure, but may or may not necessarily be combined in the same embodiments. Note also that a module, engine, client, controller, function, logic or the like as used herein in this Specification, can be inclusive of an executable file comprising instructions that can be understood and processed on a server, computer, processor, machine, compute node, combinations thereof, or the like and may further include library modules loaded during execution, object files, system files, hardware logic, software logic, or any other executable modules.

It is also noted that the operations and steps described with reference to the preceding figures illustrate only some of the possible scenarios that may be executed by one or more entities discussed herein. Some of these operations may be deleted or removed where appropriate, or these steps may be modified or changed considerably without departing from the scope of the presented concepts. In addition, the timing and sequence of these operations may be altered considerably and still achieve the results taught in this disclosure. The preceding operational flows have been offered for purposes of example and discussion. Substantial flexibility is provided by the embodiments in that any suitable arrangements, chronologies, configurations, and timing mechanisms may be provided without departing from the teachings of the discussed concepts.

As used herein, unless expressly stated to the contrary, use of the phrase ‘at least one of’, ‘one or more of’, ‘and/or’, variations thereof, or the like are open-ended expressions that are both conjunctive and disjunctive in operation for any and all possible combination of the associated listed items. For example, each of the expressions ‘at least one of X, Y and Z’, ‘at least one of X, Y or Z’, ‘one or more of X, Y and Z’, ‘one or more of X, Y or Z’ and ‘X, Y and/or Z’ can mean any of the following: 1) X, but not Y and not Z; 2) Y, but not X and not Z; 3) Z, but not X and not Y; 4) X and Y, but not Z; 5) X and Z, but not Y; 6) Y and Z, but not X; or 7) X, Y, and Z.

Additionally, unless expressly stated to the contrary, the terms ‘first’, ‘second’, ‘third’, etc., are intended to distinguish the particular nouns they modify (e.g., element, condition, node, module, activity, operation, etc.). Unless expressly stated to the contrary, the use of these terms is not intended to indicate any type of order, rank, importance, temporal sequence, or hierarchy of the modified noun. For example, ‘first X’ and ‘second X’ are intended to designate two ‘X’ elements that are not necessarily limited by any order, rank, importance, temporal sequence, or hierarchy of the two elements. Further as referred to herein, ‘at least one of’ and ‘one or more of’ can be represented using the ‘(s)’ nomenclature (e.g., one or more element(s)).

In summary, the techniques presented herein maintain disengagement of an electrically released brake using an auxiliary power supply when the main (high voltage) power supply of a vehicle experiences a fault. In the event of a main power loss event, the VCM detects the change and engages control circuitry in order to maintain the brake in the released state by utilizing power from a secondary (low voltage) power supply. This mode of operation is maintained until the VCM obtains data from sensors indicating that the vehicle has reached a speed that is low enough to permit safe engagement of the brake. Once the VCM detects that the vehicle speed in low enough, the VCM activates control circuitry to engage the brake, which stops the vehicle and prevents further movement.

Each example embodiment disclosed herein has been included to present one or more different features. However, all disclosed example embodiments are designed to work together as part of a single larger system or method. The disclosure explicitly envisions compound embodiments that combine multiple previously-discussed features in different example embodiments into a single system or method.

One or more advantages described herein are not meant to suggest that any one of the embodiments described herein necessarily provides all of the described advantages or that all the embodiments of the present disclosure necessarily provide any one of the described advantages. Numerous other changes, substitutions, variations, alterations, and/or modifications may be ascertained to one skilled in the art and it is intended that the present disclosure encompass all such changes, substitutions, variations, alterations, and/or modifications as falling within the scope of the appended claims.

What is claimed is:

1. A personal transportation vehicle, comprising:
a seating area within which a driver is disposed during operation of the personal transportation vehicle;
at least one electric brake that, in an engaged position, prevents the personal transportation vehicle from moving, the at least one electric brake being disposed in the engaged position when an insufficient amount of power is delivered to the at least one electric brake and being disposed in a disengaged position when a sufficient amount of power is delivered to the at least one electric brake; and
a receptacle containing electrical connectors to the at least one electric brake, the receptacle being accessible from the seating area during operation of the personal transportation vehicle.

2. The personal transportation vehicle of claim 1, wherein, aside from being electrically connected to the at least one electric brake, the receptacle is electrically isolated from operating components of the personal transportation vehicle.

3. The personal transportation vehicle of claim 2, wherein the personal transportation vehicle operates in a tow mode when a portable power source is electrically connected to the receptacle and delivering the sufficient amount of power to move the at least one electric brake to the disengaged position.

4. The personal transportation vehicle of claim 3, wherein the personal transportation vehicle is unable to operate in a drive mode while the portable power source is a sole source of power delivering the sufficient amount of power to disengage the at least one electric brake.

5. The personal transportation vehicle of claim 1, wherein the receptacle is located in a console of the personal transportation vehicle.

6. The personal transportation vehicle of claim 1, further comprising:
a portable power source that is removably installable in the receptacle.

7. The personal transportation vehicle of claim 6, wherein the receptacle is configured to removably, electrically connect to the portable power source.

8. The personal transportation vehicle of claim 6, wherein the receptacle removably, mechanically couples the portable power source to the personal transportation vehicle.

9. The personal transportation vehicle of claim 8, wherein the portable power source is contained within a canister; the canister having a handle on at least one side that is not adjacent to the receptacle upon when the canister is installed in the cavity.

10. The personal transportation vehicle of claim 1, further comprising one or more main power sources configured to operate the at least one electric brake to move the at least one electric brake between the engaged position and the disengaged position unless prevented by a fault or by lack of available power.

11. The personal transportation vehicle of claim 1, wherein the at least one electric brake is a parking brake and the personal transportation vehicle comprises additional brakes.

12. An electric brake system, comprising:
at least one electric brake that, in an engaged position, prevents a personal transportation vehicle in which it is included from moving, the at least one electric brake being disposed in the engaged position when an insufficient amount of power is delivered to the at least one electric brake and being disposed in a disengaged position when a sufficient amount of power is delivered to the at least one electric brake; and
a portable power source that can be removably, electrically connected to the at least one electric brake to provide sufficient power to open the at least one electric brake.

13. The electric brake system of claim 12, wherein the portable power source can supply the sufficient amount of power to the at least one electric brake without supplying power to other operating components of the personal transportation vehicle.

14. The electric brake system of claim 12, wherein the personal transportation vehicle will not operate other operating components of the personal transportation vehicle while the portable power source is supplying power to the at least one electric brake.

15. The electric brake system of claim 12, wherein the at least one electric brake is a parking brake of the personal transportation vehicle and the personal transportation vehicle comprises additional brakes.

16. The electric brake system of claim 12, further comprising one or more main power sources configured to operate the at least one electric brake to move the at least one electric brake between the engaged position and the disengaged position unless prevented by a fault or by lack of available power.

17. The electric brake system of claim 12, further comprising a receptacle disposed on the personal transportation vehicle, the receptacle comprising:
electrical connectors configured to removably, electrically connect the portable power source to the personal transportation vehicle; and
mechanical couplers configured to removably, mechanically connect the portable power source to the personal transportation vehicle.

18. A portable power system for a personal transportation vehicle, comprising:
a portable power source configured to deliver an amount of power sufficient for powering at least one electric brake to move the at least one electric brake out an engaged position that prevents the personal transportation vehicle from moving; and
a canister in which the portable power source is housed, the canister including external electrical connectors configured to engage connectors of the personal transportation vehicle that are accessible from a seating area of the personal transportation vehicle.

19. The portable power system of claim 18, further comprising:
the portable power source can removably and electrically connect to the at least one electric brake to provide sufficient power to move the at least one electric brake to a disengaged position.

20. The portable power system of claim 18, wherein the canister is sized to be hand carried.
